(19) United States
(12) Patent Application Publication
(10) Pub. No.: US 2013/0332032 A1
(43) Pub. Date: Dec. 12, 2013

(54) METHOD AND CONTROL UNIT FOR ACTIVATING A SAFETY DEVICE FOR A VEHICLE IN A ROLLOVER SITUATION

(71) Applicants: Christian KORN, Stuttgart (DE); Oliver LANGOHR, Weilimdorf (DE)

(72) Inventors: Christian KORN, Stuttgart (DE); Oliver LANGOHR, Weilimdorf (DE)

(73) Assignee: ROBERT BOSCH GMBH, Stuttgart (DE)

(21) Appl. No.: 13/915,250

(22) Filed: Jun. 11, 2013

(30) Foreign Application Priority Data
Jun. 11, 2012 (DE) 10 2012 209 737.6

(51) Int. Cl. B60R 21/0132

(52) U.S. Cl. CPC B60R 21/0132
USPC 701/46; 701/45

(57) ABSTRACT

A method for activating a safety device for a vehicle in a rollover situation is described. The method includes determining an activation signal for activating the safety device based on a variable representing the angle of inclination of the vehicle in a transverse direction of the vehicle and a variable representing the steering angle of a wheel of the vehicle.

### FIELD OF THE INVENTION

The present invention relates to a method for activating a safety device for a vehicle in a rollover situation, to a corresponding control unit as well as to a corresponding computer program product.

### BACKGROUND INFORMATION

To protect the passengers, safety devices such as seatbelt tensioners and side or curtain airbags may be triggered in the case of a vehicle rollover about the vehicle longitudinal axis.

### SUMMARY

Against this background, a method for activating a safety device for a vehicle in a rollover situation, furthermore a control unit which uses this method, as well as ultimately a corresponding computer program product are presented by the present invention.

The detection and determination of a triggering point in time of a safety device may be carried out by an airbag control unit, the so-called airbag ECU. A sensor may be located on the airbag control unit which measures the yaw rate (omega_x) about the vehicle x axis, also referred to as the longitudinal axis. Moreover, a particular rollover sensing algorithm (RoSe), which chronologically integrates yaw rate omega_x about the vehicle x axis and thus determines rotation angle phi_x and compares the low-pass filtered yaw rate to an angle-dependent threshold, may be executed on a microcontroller. If the angle-dependent and applicable threshold is exceeded by the filtered yaw rate and a fire threshold is reached, a safety device or a restraint device may be ignited.

In general, the above-mentioned fire threshold conforms with the principle of the conservation of energy, the rotation angle describing the instantaneous potential energy of the vehicle and the yaw rate describing the instantaneous kinetic energy of the vehicle. If the sum of the two energies exceeds a certain value, a rollover will result. This means that the yaw-rate threshold is high at a small angle; the yaw-rate threshold becomes continuously lower as the angle increases.

Depending on what situation may result in a rollover, the angle-dependent fire threshold may be applied more or less sensitively. Algorithms may detect with the aid of the applied lateral acceleration of the vehicle whether the vehicle is located on a slope or ramp, or in a so-called soil trip rollover situation. Accordingly, the algorithms switch to a particular triggering path having the angle-dependent thresholds applicable to the particular case.

If a vehicle is laterally sliding down a slope or a ramp, the rollover probability increases as the speed increases. Here, the wheel position of the front wheels, i.e., the steering angle, may have an influence on the rollover probability in addition to speed. In this way, the rollover probability may increase when the front wheels are positioned upward with regard to the slope compared to the case when the steering angle is zero. In other words, the rollover probability may increase if the front wheels are steered against the direction of movement of the vehicle and the rollover probability may be reduced if the steering angle is in the direction of movement of the vehicle. This means that if the front wheels are directed upward with regard to the slope, a rollover may occur even at a low speed. According to the specific embodiments of the present invention, the steering angle may be taken into account for the determination of the rollover probability. This makes it possible to already make a qualitative statement on an imminent rollover at a very early stage. Such a gain of time is particularly advantageous, since some safety devices necessarily require the protection device to be triggered in due time for the protection functionality to fully unfold. The optimal point in time may be reached when the information regarding an imminent or already actually happening rollover is provided in due time.

In the case of certain rollover situations such as a slope rollover, the steering angle has a direct influence on the rollover probability, whereas the steering angle has no influence on other rollover situations such as a curb impact rollover or a soil trip rollover.

A method for activating a safety device for a vehicle in a rollover situation includes the following step:

determining an activation signal for activating the safety device based on a variable representing the angle of inclination of the vehicle in a transverse direction of the vehicle and a variable representing the steering angle of a wheel of the vehicle.

The vehicle may be a motor vehicle, e.g., a passenger car, a truck, or another commercial vehicle. A safety device may be understood to mean a passenger protection system such as an airbag system or a belt tensioner. In this case, a passenger protection system may include a protection system control unit, a triggering device for an airbag, and, for example, a side airbag or a head/shoulder airbag module, a central protection system control unit being able to activate a plurality of triggering devices and associated airbags. Here, the protection system control unit may determine the point in time for triggering the passenger protection system from the sensor data which are external to the control unit and simultaneously or alternatively from sensors which are built-in in the control unit itself. In the case of a positive triggering decision, an activation signal may be output by the protection system control unit and transmitted to the triggering device. A triggering decision may also be referred to as a fire threshold. A rollover situation may be understood to mean in this case that a vehicle rolls over, i.e., a vehicle rolls over about its longitudinal axis. A vehicle rollover may, for example, be detected using a surface-micromechanical yaw-rate sensor and high-resolution acceleration sensors in the transversal and/or vertical direction of the vehicle. The variable representing the angle of inclination of the vehicle in a vehicle transverse direction may be understood to mean the angle which is produced during a rotation about the x axis running in the direction of movement of the vehicle. For example, the variable may be a roll angle or a variable which is a function of the roll angle. The x axis may also be referred to as a roll axis or longitudinal axis. A roll angle may also be referred to as a lateral inclination angle. The variable representing the steering angle of a wheel of the vehicle may be understood to mean the wheel position of the front wheels in a vehicle, i.e., not the position of the steering wheel. This may, for example, be understood to mean the steering angle or also the central wheel steering angle of the steered axle in the force-free state.

Using the method it is, for example, possible to implement a system for activating an ignition device in slope rollover situations by using the steering angle.

According to one specific embodiment, the variable representing the angle of inclination of the vehicle in a vehicle transverse direction may be a roll angle of the vehicle. According to another specific embodiment, the variable representing the steering angle of a wheel of the vehicle may be a steering angle of the vehicle. Thus, the activation signal may be determined based on the roll angle and the steering angle of the vehicle.

For example, the variable representing the angle of inclination may be linked to the variable representing the steering angle. The activation of the safety device may be based on the linkage of the two variables. In this way, the activation signal may be determined based on the linkage of the two variables.

The activation signal may furthermore be determined based on at least one acceleration value, the acceleration value representing a linear acceleration of the vehicle. The acceleration value may represent at least one acceleration transverse to the driving direction. Furthermore, the acceleration value may represent an acceleration perpendicular to the driving direction. Furthermore, the acceleration value may also be an acceleration value transverse to the driving direction and an acceleration value perpendicular to the driving direction. Here, the acceleration value may be used for both to check the plausibility and to detect the rollover type.

Furthermore, a rollover type of the rollover situation may be ascertained based on the at least one acceleration value with the aid of a step of ascertaining. Then, in the step of determining, the activation signal may be determined based on the rollover type, the roll angle or the variable representing the angle of inclination of the vehicle in a vehicle transverse direction, and the steering angle or the variable representing the steering angle of a wheel of the vehicle. A rollover type may be differentiated between a slope rollover, a curb impact rollover, or a soil trip rollover. One specific embodiment of the present invention may detect an imminent rollover already at an early stage, in particular in the case of slope rollovers.

In a step of normalizing, the steering angle may be normalized using a maximally achievable steering angle of the vehicle to ascertain a normalized steering angle. Here, in the step of determining, the activation signal may be determined based on the normalized steering angle. This approach has the advantage that the method is to be used in a more robust manner. Accordingly, the variable representing the steering angle of a wheel of the vehicle may be normalized and used to determine the activation signal.

In a step of determining the threshold value, a threshold value may be determined by using a roll rate, the roll angle, or the variable representing the angle of inclination of the vehicle in a vehicle transverse direction, and the steering angle or the variable representing the steering angle of a wheel of the vehicle, the activation signal being determined based on the threshold value in the step of determining. The use of a threshold value makes it easier for the safety device to make a triggering decision, since now, an instantaneous vehicle state, which may be determined via instantaneous sensor values, may only be compared to the threshold value. Here, a threshold value for the fire threshold may be adapted as a direct function of the roll rate, the roll angle, and the steering angle, or the values corresponding to the roll angle and the steering angle.

In the step of determining the threshold value, the normalized steering angle may be multiplied by a predefined steering angle constant as a function of a steering angle direction put in relation to the roll angle, in order to determine a correction value for the threshold value. The threshold value may be determined using the correction value. This approach has the advantage that in the case of a steering angle directed upward in relation to the slope another correction value may be determined for the threshold value than in the case of a steering angle directed downward in relation to the slope. In this case, the variable representing the steering angle of a wheel of the vehicle may accordingly be used instead of the steering angle. The steering angle may have a different effect on the probability of a rollover situation depending on the direction in relation to the slope. This circumstance may be accounted for by using two different constants for the correction value as a function of the steering angle direction.

In the step of determining the threshold value, the roll angle may be multiplied by the steering angle as a function of a comparison of the roll angle with a maximum roll angle value and a comparison of a roll rate with a minimum roll rate value in order to obtain a result value. As a function of an algebraic sign of the result value, the threshold value may be determined by using the normalized steering angle, determined in the step of normalizing, and the predefined steering angle constant or by using the normalized steering angle, determined in the step of normalizing, and another predefined steering angle constant. The comparison or the monitoring of the roll angle for a maximum and the roll rate for a minimum may facilitate the calculation of the threshold value or the value to be compared to the threshold value, since a rollover is improbable if the roll rate is too small or the rollover is already about to occur if the roll angle is excessively large. In the first case, a calculation is not necessary, since a rollover will not occur in the foreseeable future; in the second case, the calculation may also be dispensed with, since the vehicle is already in a rollover situation and the safety device is thus ignited if the safety device has not already been triggered. In this case, the variable representing the angle of inclination of the vehicle in a vehicle transverse direction may accordingly be used instead of the roll angle.

Furthermore, the present invention provides a control unit which is designed to carry out or implement the steps of the method according to the present invention in appropriate devices. This embodiment variant of the present invention in the form of a control unit also makes it possible to achieve the object underlying the present invention rapidly and efficiently.

In the present case, a control unit may be understood as an electrical device which processes sensor signals and outputs control and/or data signals as a function thereof. The control unit may have an interface which may be implemented in hard- and/or software. In the case of hardware, the interfaces may, for example, be a part of a so-called system ASIC, which includes various functions of the control unit. It is, however, also possible that the interfaces are independent, integrated circuits or are at least partially made of discrete components. In the case of software, the interfaces may be software modules which are present on a microcontroller in addition to other software modules, for example.

The present invention furthermore provides safety equipment for a vehicle having the following characteristics:

a safety device; and
a control unit for activating a safety device, the control unit being designed to determine the activation signal for the safety device.

Safety equipment may be understood to mean a system composed of a safety device and a control unit for activating the safety device. A safety device may be understood to mean a passenger protection system. The passenger protection system may be a restraint system which includes an airbag and/or a belt tensioner, for example. The airbag may be a side airbag or a head/shoulder airbag. A yaw-rate sensor and at least one acceleration sensor may be included in the control unit. Furthermore, the control unit may have an interface for reading in the steering angle.

A computer program product having program code is also advantageous, which may be stored on a machine-readable carrier, such as a semiconductor memory, a hard disk memory, or an optical memory, and is used for carrying out the method according to one of the specific embodiments described above, when the program product is executed on a computer or a device.

### BRIEF DESCRIPTION OF THE DRAWINGS

FIG. 1 shows a schematic illustration of a vehicle having safety equipment according to one exemplary embodiment of the present invention.

FIG. 2 shows a control unit according to one exemplary embodiment of the present invention.

FIG. 3 shows a flow chart of a rollover detection algorithm according to one exemplary embodiment of the present invention.

FIG. 4 shows a flow chart of a rollover detection algorithm according to another exemplary embodiment of the present invention.

FIG. 5 shows a flow chart for determining a correction value for the threshold value according to one exemplary embodiment of the present invention.

FIG. 6 shows a first illustration of the algebraic sign convention for the roll angle and the steering angle based on a standing vehicle.

FIG. 7 shows a second illustration of the algebraic sign convention for the roll angle and the steering angle based on a standing vehicle.

### DETAILED DESCRIPTION

In the following description of preferred exemplary embodiments of the present invention, the elements which are illustrated in the various figures and appear to be similar are identified with identical or similar reference numerals; a repetitive description of these elements is dispensed with.

FIG. 1 shows a schematic illustration of a vehicle 100 having safety equipment according to one exemplary embodiment of the present invention. In vehicle 100, a control unit 110 is situated which is connected to a rotation angle sensor 120, which outputs a roll rate 125, to an acceleration sensor 130, which outputs an acceleration value 135, and to a steering angle sensor 140, which outputs a steering angle 145. Furthermore, control unit 110 is connected to a safety device 150. Safety device 150 may be an airbag system. Safety device 150 may, however, also represent another passenger protection system. Control unit 110 is designed to output an activation signal 155 for safety device 150 which is received by safety device 150. Steering angle sensor 140 may also be an expanded device which is designed, for example, to calculate the steering angle based on a steering angle sensor and with the aid of a suitable algorithm.

According to one exemplary embodiment, a device for determining a variable representing the angle of inclination of vehicle 100 in a vehicle transverse direction may be provided instead of rotation angle sensor 120. The variable representing the angle of inclination of vehicle 100 in a vehicle transverse direction may correspond to the roll angle or be based on the roll angle or the roll angle may be determinable from the variable or be a function of the variable. In the following, exemplary embodiments are described using the roll angle which may be considered to be a representative example of the variable representing the angle of inclination of the vehicle in the vehicle transverse direction.

According to one exemplary embodiment, a device for determining a variable representing the steering angle of a wheel of vehicle 100 may be provided instead of steering angle sensor 140. The variable representing the steering angle of a wheel of vehicle 100 may correspond to the steering angle or be based on the steering angle or the steering angle may be determinable from the variable or be a function of the variable. In the following, exemplary embodiments are described using the steering angle which may be considered to be a representative example of the variable representing the steering angle of a wheel of vehicle 100.

Control unit 110 is designed to output a control signal to safety device 150. Furthermore, control unit 110 is designed to receive a roll rate 125 from rotation angle sensor 120 and to determine a roll angle therefrom. Control unit 110 is designed to receive a steering angle 145 from steering angle sensor 140 and an acceleration signal 135 from acceleration sensor 130. Furthermore, control unit 110 is designed to determine for the safety device a rollover type from acceleration signal 135 as well as activation signal 155 from roll rate 125, the roll angle and steering angle 145.

In one exemplary embodiment of the present invention, yaw-rate sensor 120 and the at least one acceleration sensor 130 are integrated into control unit 110. In another exemplary embodiment of the present invention, one acceleration sensor 130 measures the acceleration transverse to the driving direction and another acceleration sensor 130 measures the acceleration perpendicular to the driving direction.

The wheel position of the front wheels of vehicle 100, or steering angle 145, has an influence on the rollover probability if vehicle 100 slides down a slope. Experiments show that a rollover becomes more probable, more precisely occurs already at a low speed, if the position of the front wheels is upward in relation to the slope as compared to the case that steering angle 145 is zero.

This effect could be anticipatorily taken into account by incorporating steering angle 145 in algorithm decision 155. A fire decision 155 may then be made more rapidly.

The present invention presents an algorithm which also analyzes steering angle information 145 during a vehicle rollover and calculates modified fire thresholds for safety device 150 based on this analysis if vehicle 100 is driving on a slope. In this way, it is possible to reduce the fire threshold if steering angle 145 points upward in relation to the slope and thus a restraint device 150 may be ignited earlier than before and the protection of the passengers may be improved in such a situation. To unfold the full protection functionality, it is crucial that protection device 150 are triggered in due time.

Conversely, the algorithm also provides the setting possibility to raise the fire threshold and thus to account for a reduced rollover probability if the steering is not directed upward, i.e., downward, for example, in relation to the slope.

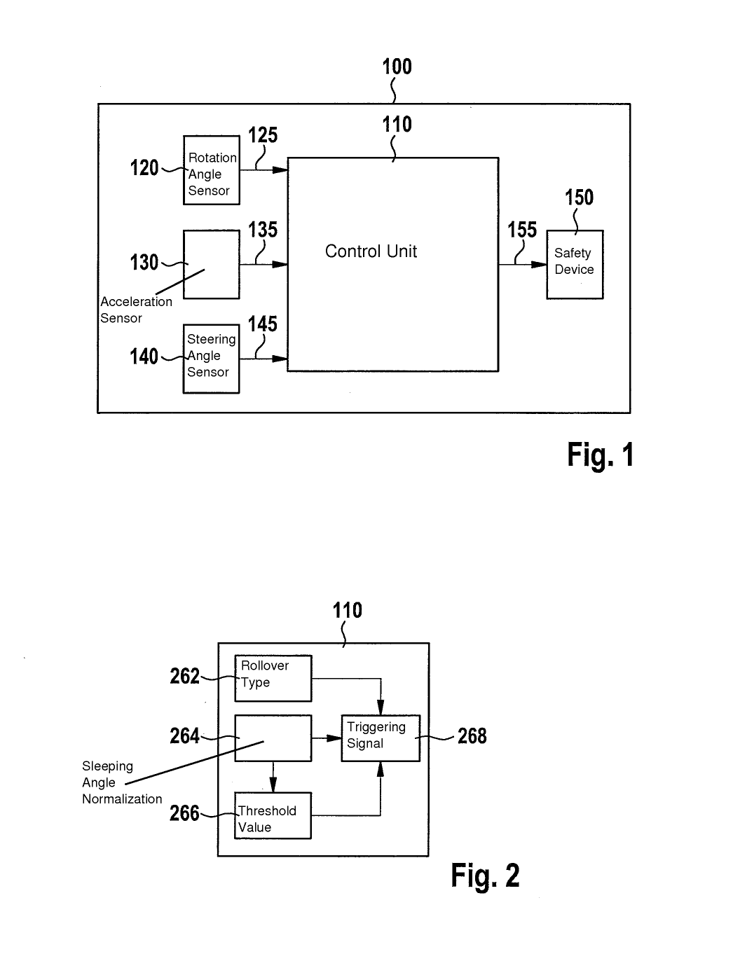

FIG. 2 shows a control unit 110 according to one exemplary embodiment of the present invention. This may be the control unit described with reference to FIG. 1. Control unit 110 has a device 262 for ascertaining the rollover type, a device 264 for normalizing a steering angle, a device 266 for determining the threshold value, as well as a device 268 for determining a triggering signal for a safety device. With the aid of devices 262, 264, 266, and 268, control unit 110 is designed to carry out or implement the steps of a method for activating a safety device for a vehicle in a rollover situation. Device 262 for ascertaining the rollover type is connected to device 268 for determining a triggering signal. Device 264 for normalizing a steering angle is connected to device 266 for determining the threshold value and to device 268 for determining the triggering signal. Furthermore, device 266 for determining the threshold value and device 268 for determining a triggering signal are interconnected.

As illustrated in FIG. 1, control unit 110 is designed to receive a roll rate from a yaw-rate sensor, an acceleration signal from an acceleration sensor, and a steering angle from a steering angle sensor. Control unit 110 is designed to further process the signals and to output an activation signal 155 for at least one safety device 150.

Device 262 for ascertaining a rollover type is designed to determine a rollover type using at least one acceleration signal. Device 264 for normalizing a steering angle is designed to determine a normalized steering angle using the steering angle and a maximum steering angle determined for the vehicle. Device 266 for determining the threshold value is designed to determine a threshold value for the triggering decision using a roll rate, the roll angle determinable from the roll rate, and the normalized steering angle. Device 268 for determining a triggering signal for a safety device is designed to determine and output a triggering signal for the safety device using the rollover type, the steering angle, the roll rate, the roll angle, as well as the threshold value for the triggering decision.

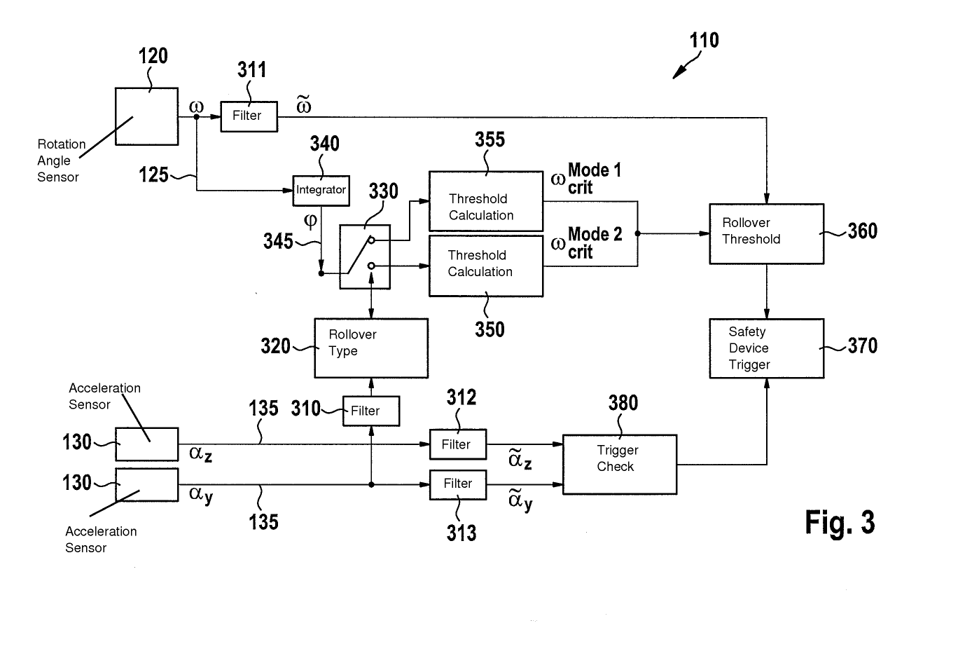

FIG. 3 shows a device which is designed to execute a rollover detection algorithm according to one exemplary embodiment of the present invention. The device may be used in the vehicle shown in FIG. 1, for example. The device has a rotation angle sensor 120, two acceleration sensors 130 as well as a control unit 110. Control unit 110 has filtering devices 310, 311, 312, 313, a device 320 for determining a rollover type, a device 330 for selecting the threshold value calculation, a device 340 for integrating, device 340 for integrating being designed to output a roll angle 345, devices for threshold value calculations 350, 355, a device 360 for monitoring the rollover threshold value, a device 370 for triggering a decision for a safety device, as well as a unit 380 for checking the triggering decision for plausibility. Device 370 for triggering a decision may be designed to output an activation signal 155 for a safety device.

One of acceleration sensors 130 is designed to provide an acceleration signal 135 which represents an acceleration a_{z} perpendicular to the driving direction in the direction of a vertical axis of the vehicle. The other acceleration sensor 130 is designed to provide an additional acceleration signal 135 which represents an acceleration a_{y} transverse to the driving direction of the vehicle. One of filtering devices 310 is designed to receive the two acceleration signals 135, to generate a filtered acceleration signal, and to output the filtered acceleration signals to a device 320 for determining a rollover type. Device 320 for determining a rollover type is designed to receive the filtered acceleration signals. In device 320 for determining a rollover type, a rollover type is determined from the two filtered acceleration signals, it being possible to differentiate between a slope rollover, a curb impact rollover, or a soil trip rollover. Device 320 for determining a rollover type is designed to output the rollover type to a device 330 for selecting the threshold value calculation. A yaw-rate sensor 120 is designed to provide a yaw rate 125 or a roll rate 125. Device 340 for integrating is designed to receive a roll rate 125 and to integrate roll rate 125 over time to determine a roll angle 345. Device 340 for integrating is designed to output roll angle 345 and to forward it to device 330 for selecting the threshold value calculation. Device 330 for selecting the threshold value calculation is designed to receive roll rate 125, roll angle 345, as well as the rollover type. Device 330 for selecting the threshold value calculation is designed to select a threshold value calculation 350, 355 using the rollover type and to output the received signals to threshold value calculation 350 and to threshold value calculation 355 according to the selected threshold value calculation. Device 350 for calculating the threshold value for a slope rollover is designed to receive roll rate 125 and roll angle 345 and to accordingly determine a threshold value for triggering a safety device for a slope rollover. Device 350 for calculating the threshold value is designed to output the calculated threshold value. Device 355 for calculating the threshold value for a curb rollover or a soil trip rollover is designed to receive roll rate 125 and roll angle 345 and to accordingly determine a threshold value for triggering a safety device for a curb rollover or a soil trip rollover. Device 355 for calculating the threshold value is designed to output the calculated threshold value.

Filter 311 is designed to receive roll rate 125 of yaw-rate sensor 120, to filter roll rate 125 to determine a filtered roll rate, and to output the filtered roll rate. Device 360 for monitoring the rollover threshold value is designed to receive the filtered roll rate as well as the threshold value for triggering a safety device. Device 360 for monitoring the rollover threshold value is designed to compare the absolute value of the filtered roll rate to the threshold value for triggering a safety device and to output the result as a triggering decision. Device 370 for triggering a decision is designed to receive the triggering decision of device 360 for monitoring the rollover threshold value. Device 370 for triggering a decision is furthermore designed to receive the result of unit 380 for checking the triggering decision for plausibility and to output an activation signal if there is a plausibility and a positive triggering decision.

Filter 312 is designed to receive an acceleration signal 135 from an acceleration sensor 130, to filter acceleration signal 135, and to output the result as a filtered acceleration signal. Filter 313 is designed to receive an additional acceleration signal 135 from another acceleration sensor 130, to filter additional acceleration signal 135, and to output the result as an additional filtered acceleration signal. Unit 380 for checking the triggering decision for plausibility is designed to receive the filtered acceleration signal as well as the additional filtered acceleration signal and to determine the plausibility for a rollover from the two acceleration signals. Unit 380 for checking the triggering decision for plausibility is furthermore designed to output the result of the plausibility check.

FIG. 3 shows the data flow of an algorithm in a simplified manner. Also, the plausibility checking path which runs in parallel to the yaw-rate-based decision is shown to be based on the accelerations in the y and z directions.

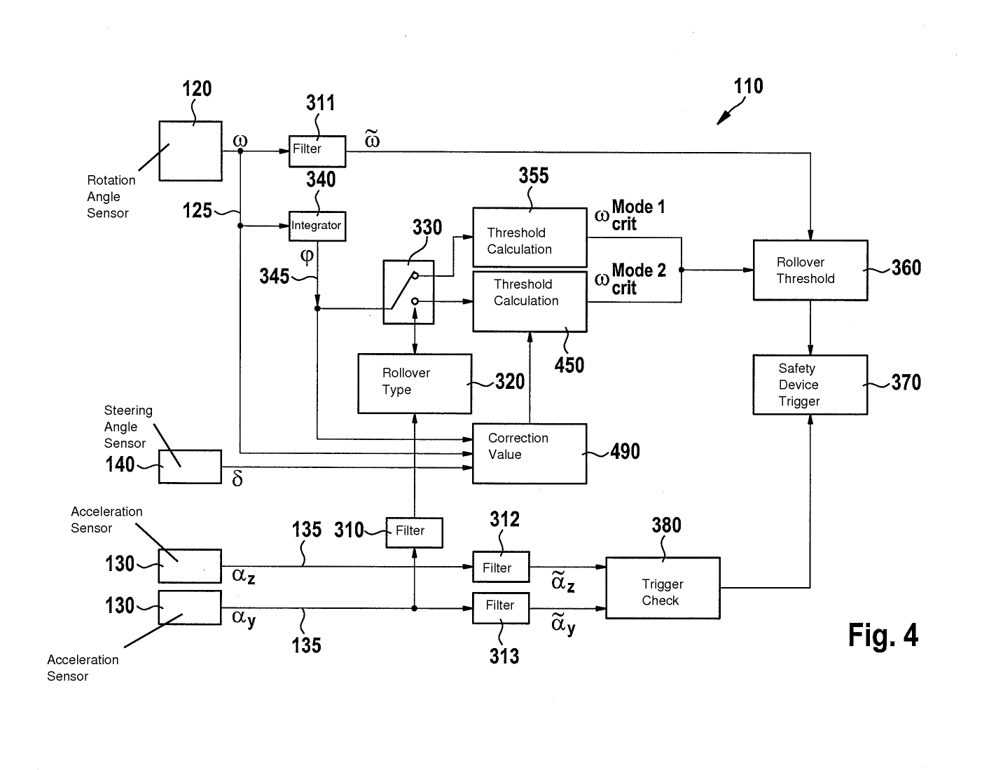

FIG. 4 shows another device which is designed to execute a rollover detection algorithm according to another exemplary embodiment of the present invention. The device largely corresponds to the device shown in FIG. 3 and has a steering angle sensor 140 in addition to a control unit 110, a rotation angle sensor 120, and two acceleration sensors 130. In contrast to the control unit shown in FIG. 3, control unit 110 has a device 450 for calculating the threshold value as well as an additional unit 490 for determining the threshold value correction value instead of device for calculating the threshold value 350 shown there.

Device 330 for selecting the threshold value calculation is designed to select a threshold value calculation 355, 450 using the rollover type and to output the received signals to threshold value calculation 450 and to threshold value calculation 355 according to the selected threshold value calculation. Unit 490 for determining a threshold value correction value is designed to receive roll rate 125, roll angle 345, as well as steering angle 145, to determine a correction value for the threshold value calculation, and to output the determined correction value for the threshold value calculation. Device 450 for calculating the threshold value for a slope rollover is designed to receive roll rate 125, roll angle 345, and the correction value for the threshold value calculation, and to accordingly determine a threshold value for triggering a safety device for a slope rollover. Device 450 for calculating the threshold value is designed to output the calculated threshold value.

In the exemplary embodiment shown in FIG. 4, the algorithm illustrated in FIG. 3 is expanded by the “SteeringAngleAddOn” module.

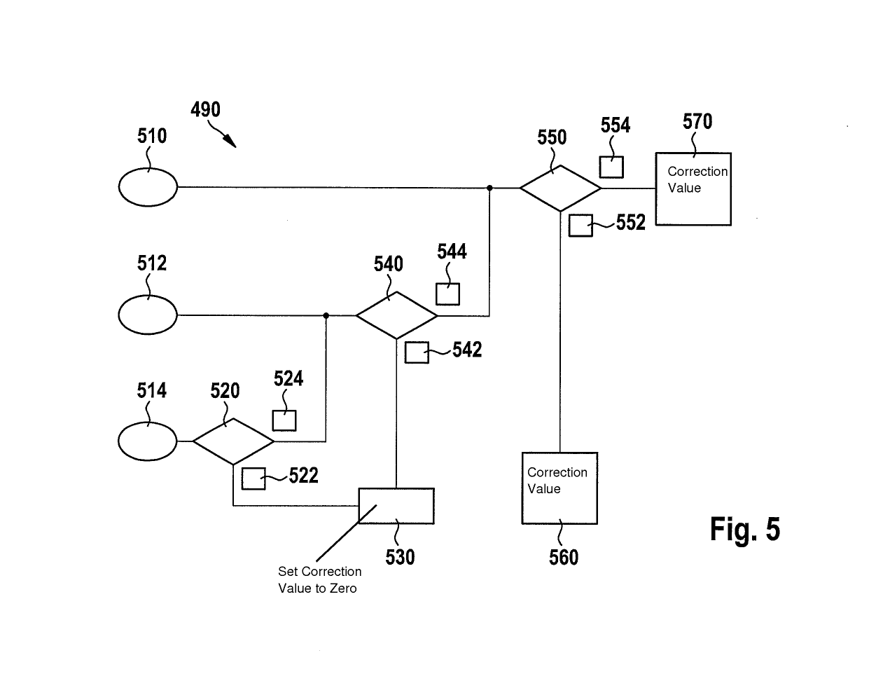

FIG. 5 shows a flow chart of a method for determining a threshold value correction value according to one exemplary embodiment of the present invention. The method may be carried out in a unit 490 for determining a threshold value correction value, as the one unit described with reference to FIG. 4. The method may be used, for example, to determine the correction value for the threshold value in a rollover detection algorithm.

The method has a block 510, which provides a steering angle δ, a block 512, which provides a roll angle φ, and a block 514, which provides a roll rate ω. A selection block 520 is designed to receive roll rate ω and to compare read-in roll rate ω to a previously defined minimum roll rate ωₘᵢₙ. Selection block 520 is designed for the purpose of carrying out function ω>ωₘᵢₙ. In the case of a negative result 522 of comparison ω>ωₘᵢₙ in block 520, in which roll rate ω is not greater than previously defined minimum roll rate ωₘᵢₙ, a correction value for threshold value calculation AddOn_value is set to zero in block 530. In the case of a positive result 524 of comparison ω>ωₘᵢₙ in block 520, in which roll rate ω is greater than previously defined minimum roll rate ωₘᵢₙ, roll angle φ is compared to a previously defined maximum roll angle φₘₐₓ in block 540. Block 540 is designed to receive roll angle φ and to carry out function φ<φₘₐₓ. In the case of a negative result 542 of comparison φ<φₘₐₓ in block 540, i.e., in which roll angle φ is not smaller than maximum roll angle φₘₐₓ, the correction value for threshold value calculation AddOn_value is set to zero in block 530. In the case of a positive result 544 of comparison φ<φₘₐₓ in block 540, i.e., in which roll angle φ is smaller than maximum roll angle φₘₐₓ, the result of a multiplication of steering angle δ by roll angle φ is checked for a value above zero in block 550. Block 550 is designed to receive steering angle δ and roll angle φ and to carry out function δφ>0. In the case of a negative result 552 of comparison δφ>0, i.e., when the result of a multiplication of steering angle δ by roll angle φ is not greater than zero, the correction value for threshold value calculation AddOn_value is formed in block 560 with the aid of a multiplication of a predefined steering angle constant Par_AddOnIncMax by the quotient from steering angle δ and maximum steering angle of the vehicle Par_DeltaMax. Block 560 is designed to receive steering angle δ, to carry out function AddOn_value=δ*Par_AddOnIncMax/Par_DeltaMax, and to output the correction value for threshold value AddOn_value.

In the case of a positive result 554 of comparison δφ>0, i.e., when the result of the multiplication of steering angle δ by roll angle φ is greater than zero, the correction value for threshold value calculation AddOn_value is determined in block 570 with the aid of a multiplication of another predefined steering angle constant Par_AddOnLowerMax by the quotient from steering angle δ and maximum steering angle of the vehicle Par_DeltaMax. Block 570 is designed to receive steering angle δ, to carry out function AddOn_value=δ*Par_AddOnLowerMax/ParDeltaMax, and to output the correction value for threshold value AddOn_value.

Depending on the result of the described comparisons, the threshold value correction value of unit 490 is thus formed either by block 530, by block 560, or by block 570.

According to one exemplary embodiment, a module for calculating the correction value for threshold value AddOn-value using the steering angle is described in the following with reference to FIG. 5. In FIG. 5, it is shown that a correction value AddOn_value is only calculated for the triggering threshold if instantaneous roll angle φ (phi) does not yet exceed an applicable value φₘₐₓ (phi_max), since only then does the wheel position take full effect and only then may a performance improvement be achieved. Optionally, a minimum roll rate may also be determined below which a correction value AddOn_value is not calculated. If both above-mentioned conditions are met, it is differentiated between two cases depending on the algebraic sign convention of the angles.

In a first case, the steering is upward in relation to the slope, i.e., phi*delta>0. Then, the following applies to the correction value:

AddOn_value=delta*Par_AddOnLowerMax/Par_DeltaMax.

Here, parameter Par_DeltaMax is applied in such a way that it corresponds to the maximally reachable steering angle of the particular vehicle. With the aid of parameter Par_AddOnLowerMax (>=0), the meaning of the correction value, i.e., the AddOn strength, may be set.

In a second case, the steering is downward in relation to the slope, i.e., phi*delta<0. Then, the following applies to the correction value:

AddOn_value=delta*Par_AddOnIncMax/Par_DeltaMax.

Here, parameter Par_DeltaMax is applied in such a way that it corresponds to the maximally reachable steering angle of the particular vehicle. With the aid of parameter Par_AddOnIncMax (<=0), the meaning of the correction value, i.e., the AddOn strength, may be set.

In the approach suggested here, each correction value AddOn_value is proportional to instantaneous steering angle δ. Alternatively, only a fixed correction value may be used for threshold value AddOn_value upon reaching a particular steering angle δ.

Corresponding to the exemplary embodiment shown in FIG. 4, calculated correction value AddOn_value is added to the applied angle-dependent threshold for the instantaneous (filtered) roll rate, for the case that the ramp/slope path was selected. The following applies:

Omeg_crit=Omega_crit+AddOn_value

This is used to make the threshold more sensitive or robust and to accordingly adapt the triggering point in time to the situation.

The explicit identifications mentioned with reference to FIG. 5 are only mentioned as an example and are not actually relevant to the described function. For example, a slightly different implementation may also be selected for operating time reasons.

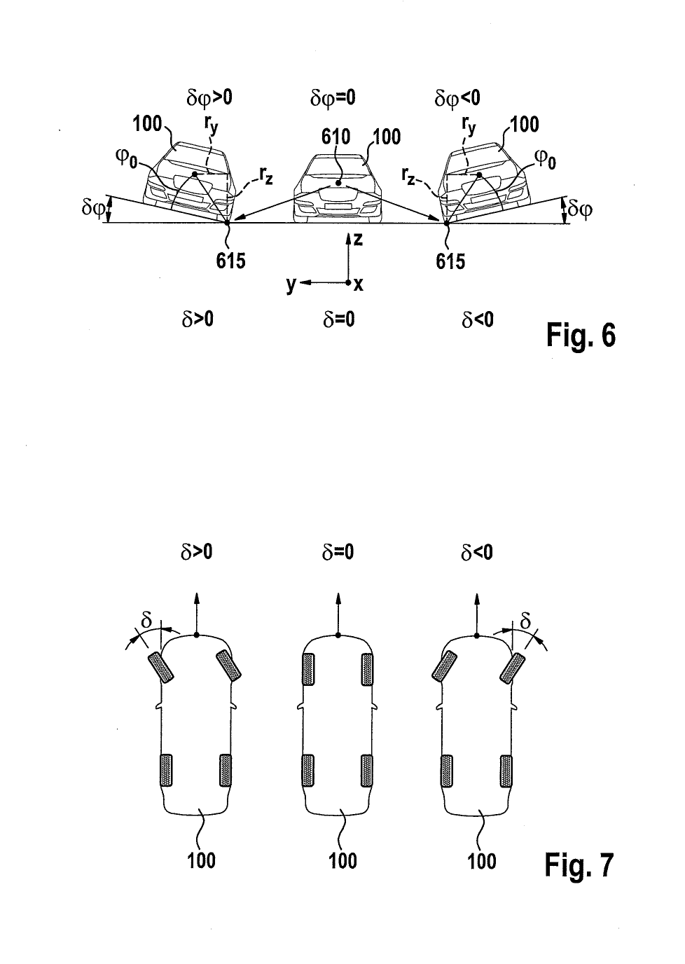

FIGS. 6 and 7 show the algebraic sign convention for the roll angle and the steering angle based on a standing vehicle. Here, FIG. 6 shows the standing vehicle from behind and FIG. 7 shows the standing vehicle from above.

FIG. 6 shows a vehicle 100 from behind in three views. Here, the central view shows the vehicle in the plane and the other two views show the vehicle in a rotation situation. The central view shows vehicle 100 having a steering angle δ of zero and a roll angle φ of zero. Point of rotation 610 is inside the vehicle. The point of rotation is a rotation axis which runs in parallel to the vehicle longitudinal axis. The vehicle coordinate system is a Cartesian coordinate system. The x axis corresponds to the vehicle longitudinal axis from the rear to the front of the vehicle. Thus, the x axis runs away from the observer in FIG. 6. The y axis stands perpendicularly on the x axis and runs in the driving plane. The y axis is also referred to as the pitch or the transverse axis. It runs to the left in FIG. 6. A rotation about the y axis running perpendicularly to the x axis of the vehicle is referred to as pitching. The z axis standing perpendicularly on the x-y plane of the vehicle is also referred to as a yaw or a vertical axis. The right-hand view of vehicle 100 shows vehicle 100 in a rotation situation. A point of rotation 615 is on the outer edge of the wheels on the left-hand side of the vehicle at the point of intersection with a roadway or a standing area of vehicle 100. Roll angle φ₀ has its vertex in point of rotation 615, one leg of roll angle φ₀ runs in the roadway or the standing area of the vehicle, and the other leg of roll angle φ₀ runs through the point which identifies point of rotation 610 in the plane in a standing vehicle. A projection of point of rotation 610 of the standing vehicle on the y axis and the z axis yields a radius r_{y} and a radius r_{z}. The multiplication of φδ is smaller than zero, assuming that the steering angle is smaller than zero.

The left-hand view of vehicle 100 shows vehicle 100 in a rotation situation. A point of rotation 615 is on the outer edge of the wheels on the right-hand side of the vehicle at the point of intersection with a roadway or a standing area of vehicle 100. Roll angle φ₀ has its vertex in point of rotation 615, one leg of roll angle φ₀ runs in the roadway or the standing area of the vehicle, and the other leg of roll angle φ₀ runs through the point which identifies point of rotation 610 in the plane in a standing vehicle. A projection of point of rotation 610 of the standing vehicle on the y axis and the z axis yields a radius r_{y} and a radius r_{z}. The multiplication of φδ is greater than zero, assuming that steering angle δ is greater than zero.

FIG. 7 shows a vehicle 100 from above in three views. The positive x axis runs in the driving direction of vehicle 100. The central view of vehicle 100 does not have a steering angle, i.e., steering angle δ is zero. The wheels of vehicle 100 in the right-hand view are turned to the right. Steering angle δ is defined as being smaller than zero. The wheels of vehicle 100 in the left-hand view are turned to the left. Steering angle δ is defined as being greater than zero.

The exemplary embodiments described and shown in the figures have only been selected as examples. Different exemplary embodiments may be combined with each other in their entirety or with regard to their individual features. Also, one exemplary embodiment may be supplemented with features of another exemplary embodiment. Furthermore, method steps according to the present invention may be repeated and executed in a sequence different from the one described.

What is claimed is:

1. A method for activating a safety device for a vehicle in a rollover situation, the method comprising:
determining an activation signal for activating the safety device based on a variable representing an angle of inclination of the vehicle in a transverse direction of the vehicle and a variable representing a steering angle of a wheel of the vehicle.

2. The method as recited in claim 1, wherein the variable representing the angle of inclination of the vehicle in the transverse direction of the vehicle is a roll angle of the vehicle.

3. The method as recited in claim 1, wherein the variable representing the steering angle of the wheel of the vehicle is a steering angle of the vehicle.

4. The method as recited in claim 1, further comprising:
providing a linkage of the variable representing the angle of inclination to the variable representing the steering angle, wherein an activation of the safety device is based on the linkage.

5. The method as recited in claim 1, further comprising:
determining the activation signal based on at least one acceleration value representing a linear acceleration of the vehicle.

6. The method as recited in claim 5, further comprising:
ascertaining a rollover type of the rollover situation based on the at least one acceleration value; and
in the determining of the activation signal, determining the activation signal based on the rollover type, a roll angle of the vehicle, and the steering angle of the vehicle.

7. The method as recited in claim 6, further comprising:
normalizing the steering angle using a maximally achievable steering angle of the vehicle to ascertain a normalized steering angle; and
in the step of determining the activation signal, determining the activation signal based on the normalized steering angle.

8. The method as recited in claim 2, further comprising:
determining a threshold value using a roll rate, the roll angle, and a steering angle of the vehicle; and
in the determining of the activation signal, determining the activation signal based on the threshold value.

9. The method as recited in claim 8, further comprising:
in the determining of the threshold value, multiplying a normalized steering angle by a predefined steering angle constant as a function of a steering angle direction put in relation to the roll angle, in order to determine a correction value for the threshold value; and
determining the threshold value using the correction value.

10. The method as recited in claim 9, further comprising:
in the determining of the threshold value, multiplying the roll angle by the steering angle as a function of a comparison of the roll angle with a maximum roll angle value and a comparison of the roll rate with a minimum roll rate value in order to obtain a result value; and
as a function of an algebraic sign of the result value, determining the threshold value by using one of:
the normalized steering angle normalized using a maximally achievable steering angle of the vehicle and the predefined steering angle constant, and
the normalized steering angle and another predefined steering angle constant.

11. A control unit for activating a safety device for a vehicle in a rollover situation, comprising:
an arrangement for determining an activation signal for activating the safety device based on a variable representing an angle of inclination of the vehicle in a transverse direction of the vehicle and a variable representing a steering angle of a wheel of the vehicle.

12. A safety equipment for a vehicle, comprising:
a safety device; and
a control unit for activating the safety device, the control unit comprising:
an arrangement for determining an activation signal for activating the safety device based on a variable representing an angle of inclination of the vehicle in a transverse direction of the vehicle and a variable representing a steering angle of a wheel of the vehicle.

13. A computer program product having program code that when executed on a device carries out a method for activating a safety device for a vehicle in a rollover situation, the method comprising:
determining an activation signal for activating the safety device based on a variable representing an angle of inclination of the vehicle in a transverse direction of the vehicle and a variable representing a steering angle of a wheel of the vehicle.
